(19) United States
(12) Patent Application Publication
(10) Pub. No.: US 2026/0167335 A1
(43) Pub. Date: Jun. 18, 2026

(54) AIRCRAFT SECTION AND AIRCRAFT WITH ADDITIONAL SEAT BELT

(71) Applicant: Airbus Operations GmbH, HAMBURG (DE)

(72) Inventors: Markus FRITZ, HAMBURG (DE); Dennis BEHNKE, HAMBURG (DE)

(21) Appl. No.: 19/416,467

(22) Filed: Dec. 11, 2025

(30) Foreign Application Priority Data
Dec. 13, 2024 (EP) 24219647.5

(51) Int. Cl. B64D 11/06; B64C 1/06

(52) U.S. Cl. CPC B64D 11/062; B64C 1/068

(57) ABSTRACT

An aircraft section and an aircraft with an additional seat belt, the belt reel of which is attached to a primary structure assembly of frames and stringers for the aircraft section. The seat belt is guided through an opening in a side panel element into a passenger cabin of the aircraft section.

### CROSS-REFERENCE TO RELATED APPLICATIONS

This application claims priority to European Patent Application No. 24 219 647.5 filed Dec. 13, 2024, the entire disclosure of which is incorporated herein by way of reference.

### FIELD OF THE INVENTION

The present disclosure relates to an aircraft section and an aircraft with an additional seat belt. In particular, the present disclosure relates to an aircraft section and an aircraft having a seat belt anchored in the primary structure.

### BACKGROUND OF THE INVENTION

In aircraft, passengers must be protected from head injuries in the event of severe deceleration of the aircraft (e.g. heavy braking and/or impact). One component of this protection is a seat belt, in particular a two-point belt or lap belt, which is strapped around the passenger's pelvis to keep the passenger in the passenger seat. Another component is to design elements located in front of a passenger seat in such a way that they do not break and/or splinter, thereby at least preventing more serious injuries if a passenger hits them with their head.

In some seat configurations, such as in business class or first class, there are also three-point seat belts, whereby, for example, the shoulder belt is attached to a (nearly) standard two-point seat belt.

However, in some areas of the aircraft cabin it is not possible to provide a three-point seat belt. For example, the backrests of thin seats, such as those often used in economy class to save space, cannot withstand the loads that can occur with a three-point seat belt. It would also restrict the space and comfort for the passenger sitting behind. On the other hand, fixtures in the passenger cabin may be too close to a passenger seat, posing a risk of injury in the event of severe deceleration. Therefore, when viewed in the longitudinal direction of the aircraft, the entire row of passenger seats behind such fixtures is moved backwards or reduced by one seat, resulting in the loss of one passenger seat.

It is therefore an object of the present invention to provide an aircraft section and aircraft improved safety.

### SUMMARY OF THE INVENTION

This object may be solved by the present invention according to one or more embodiments described herein.

According to a first aspect for a better understanding of the present disclosure, an aircraft section delimiting a part of an aircraft cabin comprises a ladder-shaped primary structure assembly comprising at least two frames and a plurality of stringers. The frames are arranged in the circumferential direction, mostly in a cross-sectional plane of the aircraft, and thus form, for example, the cross-sectional shape of the aircraft. The stringers are arranged in the longitudinal direction of the aircraft and are arranged between two frames or span at least two adjacent frames. Furthermore, for example, an outer skin of the aircraft can be attached to the outside of the frames and/or the stringers.

The aircraft section further comprises a retaining element, a belt reel attached to the retaining element, and a seat belt wound onto the belt reel. This allows an additional seat belt to be provided in the aircraft section in the immediate vicinity of the primary structure assembly. In particular, this allows a passenger seat to be positioned (directly) next to the ladder-shaped primary structure assembly (here also referred to as an edge seat or window seat), which can benefit from the seat belt (here also referred to as a safety belt). This passenger seat can therefore also be placed in an area where no passenger seat was previously provided for the reasons mentioned above regarding the risk of injury.

As a mere example, the first row of seats behind an aircraft door that closes an opening in the outer skin of the aircraft is often set back or has one seat less, as the aircraft door has various components on the inside that could injure a passenger's head in the event of severe deceleration. Examples include the emergency slide cover, handles, levers and the like.

The (additional) seat belt provided in the aircraft section described here allows an additional restraint function for the passenger to be implemented for this edge seat. On the one hand, this allows to arrange the rows of seats closer to the door, allowing more seats to be arranged in the passenger cabin or with more comfortable spacing. On the other hand, it allows a complete row of seats to be installed without having to sacrifice an edge seat directly behind the door. Since aircrafts usually have several doors, significantly more seats can be installed in an aircraft than was previously the case; for example, at least one per door.

The belt reel has a restraint function as provided in known belt reels (also referred to as a belt retractor). The seat belt is not rolled further out of the seat belt reel when a rapid pulling movement occurs on the seat belt (out of the seat belt reel).

In an implementation variant, the retaining element can be arranged between two adjacent stringers of the plurality of stringers and attached to each of the two adjacent stringers. The retaining element is thus arranged parallel to the at least two frames, i.e. it is essentially a vertical retaining element. This allows loads from the seat belt to be transferred very effectively into the primary structure of the aircraft.

In an implementation variant, the retaining element can be arranged between two adjacent ones of the at least two frames and attached to each of the two adjacent frames. The retaining element is thus arranged parallel to the stringers, thus constituting an essentially horizontal retaining element. Likewise, loads from the seat belt can be effectively transferred to the primary structure of the aircraft.

In an implementation variant, the retaining element may be attached to one of the at least two frames. Since the frame already has good stiffening due to the arrangement of the plurality of stringers and/or the outer skin attached thereto, the loads from the seat belt can also be effectively transferred to the primary structure of the aircraft on a single frame. As an example only, the belt reel may be attached to the side of the frame. Alternatively, the frame may have a recess in which the belt retractor is arranged.

Overall, the belt reel/retractor can thus be attached directly or indirectly to the primary structure assembly. The belt retractor therefore does not take up any space in the passenger cabin and thus does not compromise comfort or pose an additional risk of injury to passengers.

In an implementation variant, the retaining element and/or the belt reel can be designed to be moved at least horizontally. This is particularly helpful because the arrangement of passenger seats in the passenger cabin is usually variable. For example, aircraft operators can install the rows of seats along seat rails in the longitudinal direction of the aircraft at different locations. In order to optimally align the belt reel in the longitudinal direction of the aircraft for the associated passenger seat, it is advantageous to move the belt reel and/or the retaining element horizontally.

As a mere example, the retaining element or the belt reel can be attached in certain spaced positions, whereby the distance between the positions can, for example, correspond to the distance at which the passenger seats can be arranged differently in the longitudinal direction.

Also by way of example only, the belt reel can also be attached to a seat rail and thus arranged in different horizontal positions. Thus, the retaining element may also be a seat rail, or the retaining element may comprise a seat rail.

In an implementation variant, the aircraft section can further comprise a side panel element that laterally defines the cabin of the aircraft and is coupled to at least some of the at least two frames and/or the plurality of stringers (such as side panel element can also be referred to as a lining or sidewall). For example, conventional holders for a side panel element may be attached to the frames and/or stringers. In any case, the side panel element covers the primary structural assembly and forms a (predominantly visible) inner boundary of the passenger cabin.

The side panel element can have an opening through which the seat belt runs. The belt reel is thus located behind the side panel element (when viewed in the radial direction from the passenger cabin), and only the seat belt runs through the opening in the side panel element.

In an implementation variant, the aircraft section can further comprise a belt deflector arranged in the opening. This allows the belt retractor to be mounted in the most favorable position with regard to mounting on the primary structure assembly, while the belt deflector ensures that the seat belt is comfortable for the passenger to wear over the shoulder.

The belt deflector may also be designed to be moved along the opening, particularly in the horizontal direction (longitudinal direction of the aircraft). This allows the belt deflector to be positioned optimally in relation to the associated passenger seat, but also in relation to the belt reel.

In an implementation variant, the aircraft section can further comprise an outer cover arranged in the opening, which covers a border of the opening. Such an outer cover serves in particular to improve the visual appearance, as it is visible from the inside, i.e. from the passenger cabin. On the other hand, the outer cover can also cover a cut edge to form the opening of the side panel element. In particular, the outer cover can also have curves (round surfaces), allowing the seat belt to slide over it easily, for example if no belt deflector is provided.

In an implementation variant, the aircraft section can further comprise an inner cover arranged in the opening, which closes the opening in the areas where the seat belt is not arranged. The inner cover may be a fixed element which is inserted, for example, in areas of the opening where no belt deflector is provided.

As a mere example, the inner cover (or inner panel) can consist of a plurality of small cover elements. This allows the opening to be variably closed in the areas in front of and behind the seat belt, depending on the horizontal position of the seat belt relative to the opening in the side panel element. It is to be understood that the cover elements can also be arranged only in front of or behind the seat belt if it is located at one of the ends of the opening. The same applies to the use of a belt deflector that already closes a small part of the opening.

Alternatively, a belt opening can be provided in the inner cover through which the seat belt is guided. Depending on where the belt opening is located in the inner cover, the position of the seat belt relative to the corresponding passenger seat can be set. In other words, the belt opening forms a belt deflector.

On the other hand, the inner cover may also comprise bristles (like a broom) through which the seat belt is guided. The bristles are designed to be flexible so that they close the opening around the seat belt. This variant is particularly advantageous in the case of a horizontally movable belt reel, as no elements on the side panel element and/or of a cover need to be modified.

In an implementation variant, the aircraft section can further comprise at least one row of passenger seats comprising a plurality of seats. An edge seat (or window seat) located closest to the primary structure assembly can comprise a two-point belt arranged to be coupled to the seat belt. The seat belt thus forms part of a three-point belt, as it can interact with the two-point belt or supplement the two-point belt with an additional restraint option.

In an implementation variant, the edge seat can comprise a belt deflector arranged on an upper side of the edge seat. A belt deflector arranged in this way offers a high level of comfort for the passenger, as the seat belt takes a fixed position (relative to the backrest of the edge seat) in the area of the passenger's shoulder, in particular regardless of the horizontal position of the belt reel and/or where the seat belt enters the passenger cabin through the side panel element.

In an implementation variant, the two-point belt can have a hook into which an eyelet arranged at a free end of the seat belt can be hooked.

In an implementation variant, the belt reel can be arranged in the primary structure assembly such that it is located above an upper edge of the backrest of the edge seat.

In an implementation variant, the aircraft section can further comprise a belt tensioner that tightens the seat belt. The belt tensioner may be a conventional belt tensioner, which is, for example, contained in the belt reel/retractor or attached to the seat belt, for example in an area behind the side panel element, i.e., in the immediate vicinity of the ladder-shaped primary structure assembly.

According to a second aspect for a better understanding of the present disclosure, an aircraft comprises at least one aircraft section according to the first aspect or one or more of the associated implementation variants.

As a mere example, the aircraft may have several aircraft doors and one such aircraft section per aircraft door.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

### BRIEF DESCRIPTION OF THE DRAWINGS

In the following, the present disclosure will further be described with reference to exemplary implementations illustrated in the figures, in which:

FIG. 1 schematically illustrates a perspective view of an aircraft section;

FIG. 2 schematically illustrates a view of an opening with a belt deflector in a side panel element;

FIG. 3A schematically illustrates a first view of a seat belt with a belt deflector on the passenger seat;

FIG. 3B schematically illustrates a second view of the seat belt with a belt deflector on the passenger seat shown in FIG. 3A;

FIG. 4A schematically illustrates an aircraft section with a passenger wearing a seat belt;

FIG. 4B schematically illustrates details of the seat belt of FIG. 4A;

FIG. 5 schematically illustrates a perspective view of an aircraft section from a ladder-shaped primary structure assembly;

FIG. 6A schematically illustrates a first variant of a retaining element for a belt retractor;

FIG. 6B schematically illustrates a second variant of a retaining element for a belt retractor; and

FIG. 7 schematically illustrates a top view of an aircraft and two aircraft sections in detail.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from these specific details.

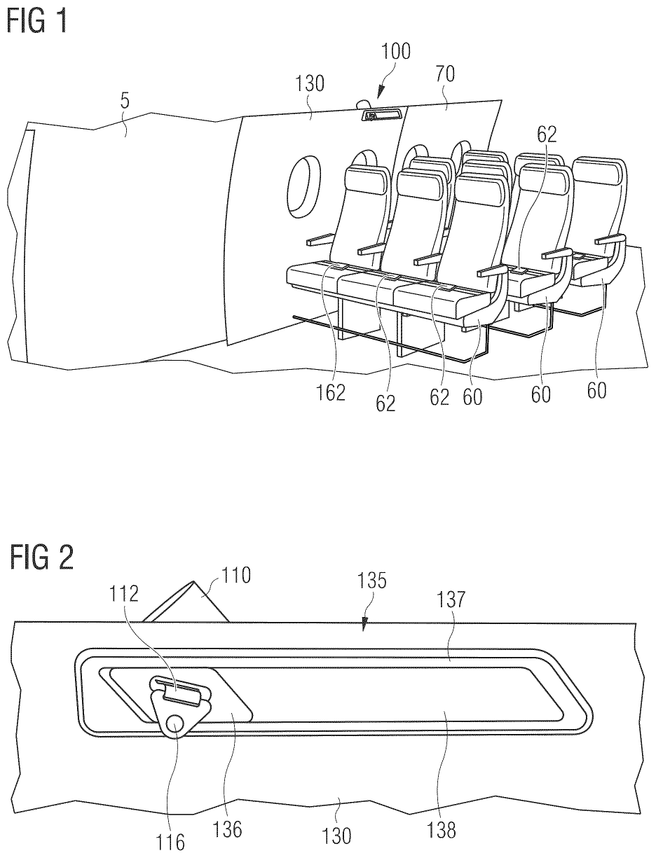

FIG. 1 schematically illustrates a perspective view of an aircraft section 100 in which several rows of passenger seats 60 are arranged. The rows of seats 60 are arranged in the longitudinal direction of the aircraft at a certain distance from each other, as it is customary in economy class, for example, between 28 inches and 38 inches (approx. 72 cm to 96.5 cm). Each passenger seat is equipped with a seat belt 62. This is a conventional two-point belt or lap belt.

The illustrated aircraft section 100 may, for example, be arranged directly behind an aircraft door 5 (door 5 is shown in FIG. 1 as an opening only). In this area, particularly for the edge seat (in FIG. 1, the left-hand seat in the first row of seats) closest to door 5, there is a problem that, in the event of a collision or severe deceleration, a passenger sitting in this seat could hit their head on an element (not shown) of the door 5 if the row of seats 60 is positioned too close to door 5.

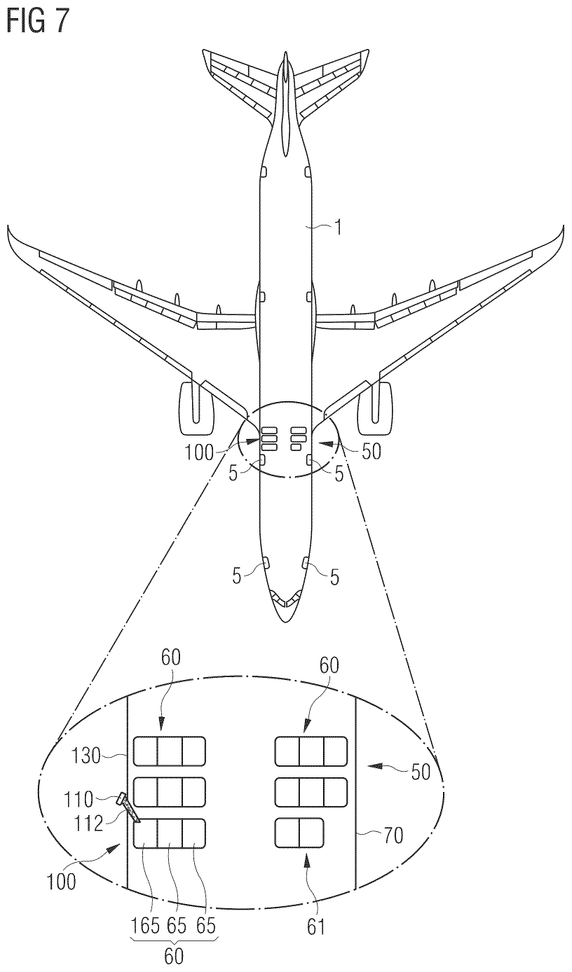

This will first be explained in more detail with reference to FIG. 7. The aircraft 1 shown in FIG. 7 has several doors 5, with the aircraft sections 50, 100 in the area of the second door 5 being considered in more detail.

For example, a typical aircraft section 50 is shown on the right-hand side of FIG. 7. The aircraft cabin is here delimited by an inner side panel element 70. In addition to the usual rows of seats 60 with, for example, three passenger seats, a further row of seats 61 with only two passenger seats is arranged directly behind door 5. The third seat next to the side panel element 70 has been omitted here. The reason for this is that various elements are arranged in the area of door 5 which protrude further into the passenger cabin than the side panel element 70. Examples include an emergency slide enclosure provided in the lower half of door 5, handles and levers for door 5, and a reinforcement frame around the door opening (which protrudes further into the interior of the passenger cabin than the usual frame 11). In the event of a severe deceleration or impact of the aircraft 1, a passenger in an edge seat directly behind door 5, secured only by a two-point seat belt, could fall forward and hit their head against one of these elements. Therefore, the edge seat in seat row 61 has been omitted.

On the left side of the detail in FIG. 7, an aircraft section 100 according to the present disclosure is shown. Here, in particular, the first row of seats after door 5 is equipped with an edge seat 165. Seat row 61 is thus a conventional seat row with a total of three passenger seats 65, 165. An additional seat belt 112 is provided for the edge seat 165. The seat belt 112 is wound onto a belt reel 110 or belt retractor, which is arranged behind a corresponding side panel element 130, with the seat belt 112 running into the passenger cabin through an opening in the side panel element 130.

Referring again to FIG. 1, it can be seen that a conventional side element 70 may be arranged in the rear area of the aircraft section. The side (panel) element 130 next to the edge seat 165, on the other hand, has an opening through which a seat belt 112 or safety belt is guided. This seat belt can be pulled down by a passenger in the edge seat 165, placed over the passenger's shoulder and anchored in a special two-point belt 162.

This creates a three-point belt that restrains the passenger in the edge seat 165 in the event of severe deceleration or impact. The edge seat 165 does not need to be modified for this purpose, as the restraint loads from the seat belt 112 are not transferred to the seat row 61.

FIG. 2 schematically illustrates a view of an opening 135 with a belt deflector 136 in a side panel element 130, as also shown schematically in FIG. 1.

The side panel element 130 can, for example, be located in front of the belt reel 110, thus covering it. In FIG. 2, the side panel element 130 is shown in such a way that part of the belt reel 110 is visible. This should not be understood as limiting the vertical position of the opening 135, but merely to illustrate that the side panel element 130 covers the belt retractor 110 (as viewed from the passenger compartment).

The belt deflector 136 arranged in the opening 135 has an opening through which the seat belt 112 is guided. A tab is provided at the free end of the seat belt 112, which has, for example, an eyelet 116 (or a simple opening). The seat belt 112 can be coupled to the special two-point belt 162 of the edge seat 165 via this eyelet 116 to form the three-point belt.

The belt deflector 136 may be designed to be moved horizontally. For example, the belt deflector 136 may be moved to any position within the opening 135 and fixed in that position. Alternatively, the belt deflector 136 may be mounted at fixed positions within the opening 135. The predetermined positions may, for example, be positions spaced 1 inch (approx. 2.54 cm) apart. This is also the usual spacing of predetermined positions at which the rows of seats 60 can be mounted longitudinally within the aircraft 1. In other words, the belt deflector 136 can be arranged in the opening 135 to match the edge seat 165.

An outer cover 137 can be arranged to conceal a cut edge of the opening 135 in the side panel element 130. The outer cover 137 can, for example, also function as a holder for the belt deflector 136.

Since the seat belt 112 can also be guided through the opening 135 without the belt deflector 136, the outer cover 137 can also be rounded to ensure that the seat belt 112 slides over the outer cover 137.

Furthermore, one or more inner covers 138 may be provided in the opening 135, which close the opening in the area(s) where the seat belt 112 (and/or the belt deflector 136) is not located. FIG. 2 shows a single inner cover 138, as the seat belt 112 is guided through the side panel element 130 at a front end of the opening 135. Of course, several inner covers 138 may be provided, in particular if the opening 135 is to be closed both in front of and behind the seat belt 112. Short inner covers (not explicitly shown) can also be used in the longitudinal direction to variably close the respective area of the opening 135 in front of and/or behind the seat belt 112.

Alternatively, the inner cover 138 can also be implemented by a plurality of bristles (not explicitly shown). These (flexible) bristles allow the seat belt 112 to pass through the opening 135 at any point in the opening 135.

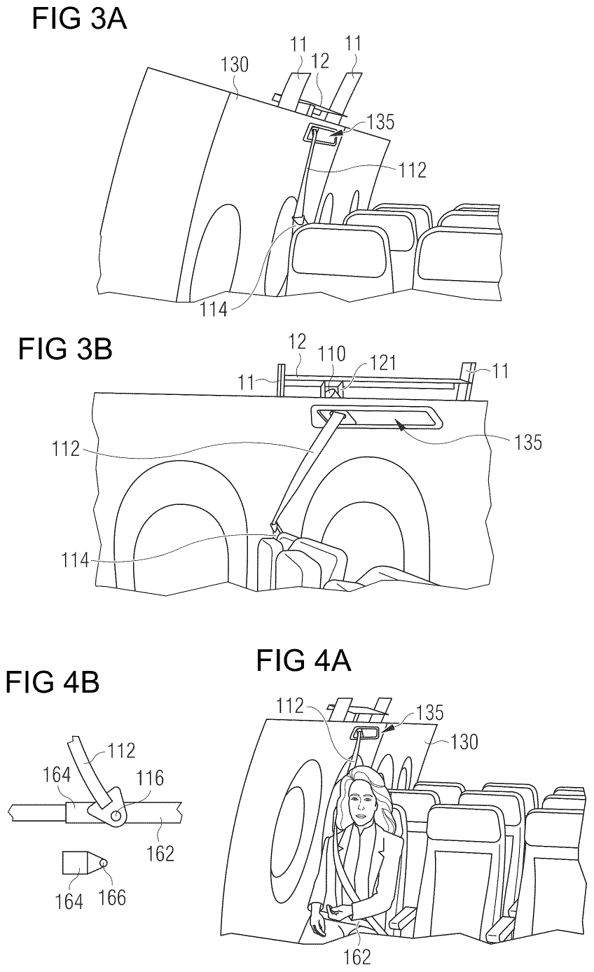

FIGS. 3A and 3B schematically illustrates views from two different angles of a seat belt 112 with a belt deflector 114 on the passenger seat, in particular the edge seat 165. This belt deflector 114 already brings the seat belt 112 from the opening 135 to a position in which the seat belt 112 is easily accessible to the passenger in the edge seat 165. In addition, the wearing comfort for the passenger in the edge seat 165 is increased, as the seat belt 112 assumes a fixed position relative to the backrest of the edge seat 165.

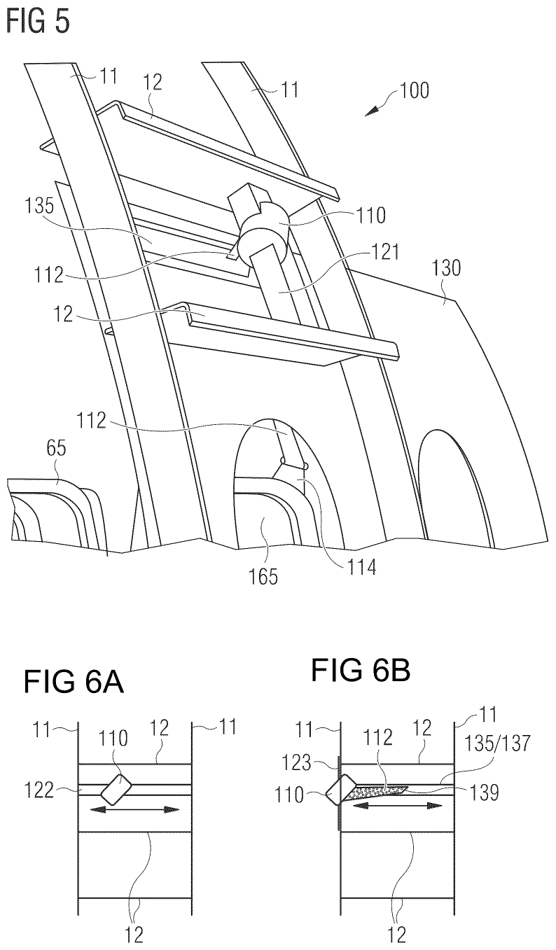

FIGS. 3A and 3B schematically illustrates parts of a ladder-shaped primary structure assembly comprising at least two frames 11 and a plurality of stringers 12 (only one stringer 12 is visible in FIGS. 3A and 3B). The belt reel 110 can be attached directly or indirectly to this primary structure assembly, as will be explained in more detail with reference to FIGS. 5, 6A, and 6B.

The belt reel 110 can be variably arranged in its horizontal position. For example, the belt reel 110 can be arranged at any position behind the opening 135. This enables optimal belt routing, for example without the seat belt 112 resting against the side panel element 130 or the outer cover 137. Such contact of the seat belt 112 could, in the event of acute use of the seat belt 112, result in damage to the side panel element 130 or cause it to be torn from its mounting.

FIG. 4A schematically an aircraft section 100 with a buckled-up passenger in the edge seat 165 and details of the seat belt 112 are shown in FIG. 4B. FIG. 4A illustrates how the seat belt 112 is guided over the shoulder of the passenger in the edge seat 165, thereby securing the passenger's upper body. This reduces the risk of the passenger leaning forward in the event of severe deceleration or impact of the aircraft 1 and hitting their head against an element in front of the edge seat 165.

The two-point seat belt 162 of the edge seat 165 may differ from a conventional two-point seat belt 62, for example, in that it has a hook 166 or similar protrusion into which the eyelet 116 of the safety belt 112 can be hooked. The hook 166 may, for example, be arranged on a buckle 164 or clasp of the two-point belt 162. Of course, a hook or similar element may be provided on the safety belt 112, which can be coupled with a corresponding element of the two-point belt 162.

FIG. 5 schematically illustrates a perspective view of an aircraft section 100 from a ladder-shaped primary structure assembly. In other words, the aircraft section 100 is viewed from the outside of the aircraft 1, with the outer skin of the aircraft 1 removed. This allows the elements of the ladder-shaped primary structure assembly to be clearly seen. These include, in particular, the frames 11 arranged in the cross-section of the aircraft and the stringers 12 arranged in the longitudinal direction of the aircraft.

The aircraft section 100 disclosed herein comprises a retaining element 121 to which the belt reel 110 is attached. FIG. 5 shows a variant in which the retaining element is arranged between two adjacent stringers of the plurality of stringers 12 and is attached to each of the two adjacent stringers 12. This allows the loads of the safety belt 112 to be transferred very effectively into the primary structure assembly.

The retaining element 121 may also be designed to be moved horizontally. For this purpose, different retaining points (not shown) may be provided on the adjacent stringers 12 to which the retaining element 121 can be attached. The distance between two such retaining points may (as described above) correspond to the distance at which the rows of seats 60 can be fastened in the longitudinal direction of the aircraft 1. Alternatively or additionally, retaining rails may be arranged on the adjacent stringers 12, in which the retaining element 121 can slide and be fastened at any position therein.

In FIG. 5, the usually present side panel element 70 at the rear in the longitudinal direction of the aircraft has been removed, revealing the usual side passenger seat 65 of the second row of seats 60. Since there is no risk of the passenger hitting their head on a component located in front of them, which could result in serious injury, no additional seat belt 112 is provided for this conventional edge seat 65.

Of course, all edge seats 65, 165 in the aircraft can also be equipped with an additional seat belt 112. To do this, several belt retractors 110 and seat belts 112 would simply need to be arranged in the respective ladder-shaped primary structure assemblies and, accordingly, several side elements 130 with opening(s) 135 would need to be arranged in the passenger cabin.

FIGS. 6A and 6B schematically illustrates two further variants of a retaining element for a belt reel 110. In FIG. 6A, the retaining element 122 is arranged between two adjacent frames 11 of the at least two frames 11 and is attached to each of the two adjacent frames 11. The retaining element 122 can be designed so that the belt reel 110 can be moved in the longitudinal direction of the aircraft 1 (horizontally), which is represented by a double arrow in FIG. 6A. The belt reel 110 can either be attached at any position along the retaining element 122 or at fixed intervals (as described above, for example, at a respective interval of 1 inch (approx. 2.54 cm)).

In FIG. 6B, another variant of a retaining element 123 is shown, which is attached to one of the at least two frames 11. The retaining element 123 can be implemented here by one or more brackets or flanges on the belt reel 110. These brackets can be attached to the frame 11. Alternatively or additionally, the retaining element 123 can be a doubling on the frame 11 to which the belt reel 110 is attached.

The seat belt 112 can, for example, be guided through the opening 135 by a belt deflector 139. Due to the fixed position of the belt reel 110 in this variant, the belt deflector 139 can be moved horizontally in order to achieve an optimum position of the seat belt 112 relative to the edge seat 165. In FIG. 6B, the belt deflector 139 is shown in the form of a slot in an inner cover 138. This would require different inner covers 138 to be provided, with the slot-shaped belt deflector 139 being provided at different horizontal positions. Alternatively, the inner cover 138 may consist of several individual elements, one of which comprises the belt deflector 139 and the others being closed covers which are inserted into the opening 135 in front of and/or behind the cover with belt deflector 139. These are merely exemplary variants. Of course, a belt deflector 136 as shown in FIG. 2 can also be used.

In FIGS. 6A and 6B, the belt reel 110 is shown to be arranged in the frame 11. In other words, the frame 11 has an opening for the belt reel 110. Of course, the belt reel 110 can also be arranged next to the frame 11, so that no opening needs to be provided in the frame 11. The latter simplifies the manufacture of the aircraft 1, and the frame 11 is not weakened by the provision of an opening.

Again with reference to FIG. 7, an aircraft section 100 may also include a combination of the two aircraft sections 50, 100 shown in FIG. 7. For example, the first row of seats 61 behind a door 5 may have fewer passenger seats 65, 165 than the other rows of seats 60. In particular, the edge seat 165 may remain free, as shown on the right in the detail of FIG. 7.

An additional seat belt 112 can also be implemented here, as described in relation to FIGS. 1 to 6B and shown schematically on the left in the detail of FIG. 7. The free space with additional seat belt 112 can now be used, for example, by a person with a wheelchair. The additional seat belt 112 provides an additional restraint option for the wheelchair in the aircraft 1.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft section delimiting a part of a cabin of an aircraft, the aircraft section comprising:
a ladder-shaped primary structure assembly comprising at least two frames and a plurality of stringers;
a retaining element;
a belt reel attached to the retaining element; and
a seat belt wound on the belt reel.

2. The aircraft section according to claim 1, wherein the retaining element is arranged between two adjacent stringers from the plurality of stringers and is attached to each of the two adjacent stringers, or
wherein the retaining element is arranged between two adjacent frames of the at least two frames and is fastened to each of the two adjacent frames, or
wherein the retaining element is fastened to one of the at least two frames.

3. The aircraft section according to claim 1, wherein the retaining element, or the belt reel, or both are arranged to be displaced at least horizontally.

4. The aircraft section according to claim 1, further comprising:
a side panel element which laterally defines the cabin of the aircraft and is coupled to at least one of the at least two frames, or to at least one stringer from the plurality of stringers, or to both,
wherein the side panel element has an opening through which the seat belt runs.

5. The aircraft section according to claim 4, further comprising:
a belt deflector arranged in the opening; or
an outer cover arranged in the opening and covering a border of the opening; or
an inner cover arranged in the opening and closing the opening in areas where the seat belt is not arranged; or
any combination thereof.

6. The aircraft section according to claim 1, further comprising:
at least one row of passenger seats comprising a plurality of seats, wherein an edge seat located closest to the primary structure assembly comprises:
a two-point belt configured to be coupled to the seat belt, or
a belt deflector disposed at an upper side of the edge seat, or both.

7. The aircraft section according to claim 6, wherein the two-point belt has a hook into which an eyelet arranged at a free end of the seat belt is configured to be hooked.

8. An aircraft comprising:
at least one aircraft section according to claim 1.
